(19) United States
(12) Patent Application Publication
(10) Pub. No.: US 2016/0061591 A1
(43) Pub. Date: Mar. 3, 2016

(54) Stationary Dimensioning Apparatus

(71) Applicants: JOHN ALAN PANGRAZIO, ISLAND LAKE, IL (US); ROBERT THOMAS PANGRAZIO, HUDSON, OH (US)

(72) Inventors: JOHN ALAN PANGRAZIO, ISLAND LAKE, IL (US); ROBERT THOMAS PANGRAZIO, HUDSON, OH (US)

(73) Assignee: LTS METROLOGY, LLC, TWINSBURG, OH (US)

(21) Appl. No.: 14/838,787

(22) Filed: Aug. 28, 2015

Related U.S. Application Data
(60) Provisional application No. 62/042,912, filed on Aug. 28, 2014.

(51) Int. Cl. G01B 11/24; G01B 11/00

(52) U.S. Cl. CPC G01B 11/24; G01B 11/002

(57) ABSTRACT

A stationary dimensioning apparatus dimensions a load on a movable conveyance by detecting a barcode fiducial that is situated on the conveyance and by detecting a large number of points in space that represent points on the surface of the load. The location of the barcode fiducial on the conveyance is compared with a reference location of a reference barcode fiducial, and a translation vector and a rotation vector are calculated to characterize the difference in translation and rotation between the reference barcode fiducial and the barcode fiducial that was detected on the conveyance. The translation and rotation vectors are then employed in a transformation matrix that is used to transform each of the detected points in space into transformed points in space that correspond with a reference coordinate system, such as might be defined in terms of horizontal and vertical directions. Those transformed space in points that are determined to be points on the surface of the conveyance itself can be ignored, and the dimensions of the load can then be calculated from the remaining transformed points in space.

### CROSS-REFERENCE TO RELATED APPLICATION

The instant application claims priority from U.S. Provisional Patent Application Ser. No. 62/042,912 filed Aug. 28, 2014, the disclosures of which are incorporated herein by reference.

### BACKGROUND

1. Field

The disclosed and claimed concept relates generally to devices that determine the physical dimensions of objects and, more particularly, to a stationary dimensioning apparatus.

2. Related Art

The dimensioning of objects is well known in the relevant art and is performed for many reasons. Such dimensioning may be performed in order to assign a dimensional weight to an object for purposes of shipping, and dimensioning may also be performed for purposes of helping a cargo receptacle to be most efficiently filled.

One such dimensioning system is a mobile dimensioning system that is set forth in U.S. Pat. No. 8,134,717 (Pangrazio), the disclosures of which are incorporated herein by reference, wherein a dimensioning apparatus is mounted to the masts of a forklift. In Pangrazio, the dimensioning apparatus scans a load that is situated on a platform of the forklift and generates a large number of points in three-dimensional space that characterize the exterior surface of the load. The three-dimensional points in space may together be referred to as a “point cloud”. The dimensioning apparatus of Pangrazio then employs the points in the point cloud to determine the physical dimensions (i.e., length, width, and height) of the load, and such information is used for billing purposes and is used during the loading of a transport device such as a cargo trailer, airplane storage compartment, etc., in order to maximize the efficiency of the loading and for other purposes. The dimensioning apparatus of Pangrazio is affixed to the forks of the forklift and thus is situated generally above the load, and the dimensioning apparatus moves with the masts and thus the load. The Pangrazio dimensioning apparatus can therefore accurately dimension the load on the forks of the forklift regardless of whether the masts are tilted rearward (which is typically the case) and/or whether the forklift may be on a non-horizontal surface.

It may also be desirable, however, to provide a dimensioning apparatus similar to the dimensioning apparatus of Pangrazio, but that is stationary (i.e., situated at a fixed location within a warehouse or other location) whereby the dimensioning apparatus can be used to detect the dimensions of loads on multiple forklifts. However, when the dimensioning apparatus is stationary and the load is situated on the forklift, the load can be in any of a wide variety of orientations and positions with respect to the dimensioning apparatus since the masts of the forklift may be tilted with respect to the vertical direction, the wheels of the forklift may be on a non-horizontal surface, and the forklift itself can be driven into the active dimensioning zone of the dimensioning apparatus in any of a variety of directions. As such, the load can effectively be positioned in a nearly limitless variety of orientations and positions with respect to the stationary dimensioning apparatus.

Some previous stationary dimensioning apparatus have employed time-of-flight devices in conjunction with some type of mechanism that moves the load past the time-of-flight devices, typically at a fixed velocity. The fixed velocity might be provided by, for example, a movable conveyance such as a conveyor belt that is moving at a fixed, known velocity, although this can be accomplished if a forklift upon which the load is situated is driven at a precise velocity past the time-of-flight devices. Some previously known dimensioning apparatuses have additionally required the various loads to be in a specific orientation with respect to the time-of-flight devices. These requirements have limited the effectiveness and usefulness of such known types of fixed dimensioning apparatuses. Improvements thus would be desirable.

### SUMMARY

Accordingly, an improved stationary dimensioning apparatus dimensions a load on a movable conveyance by detecting a barcode fiducial that is situated on the conveyance and by detecting a large number of points in space that represent points on the surface of the load. The location of the barcode fiducial on the conveyance is compared with a reference location of a reference barcode fiducial, and a translation vector and a rotation vector are calculated to characterize the difference in translation and rotation between the reference barcode fiducial and the barcode fiducial that was detected on the conveyance. The translation and rotation vectors are then employed in a transformation matrix that is used to transform each of the detected points in space into transformed points in space that correspond with a reference coordinate system, such as might be defined in terms of horizontal and vertical directions. Those transformed space in points that are determined to be points on the surface of the conveyance itself can be ignored, and the dimensions of the load can then be calculated from the remaining transformed points in space.

Accordingly, an aspect of the disclosed and claimed concept is to provide an improved dimensioning apparatus and method that enable a load that is situated in an orientation that is offset, either in terms of translation or rotation or both, from a reference coordinate system to have its dimensions calculated with respect to the reference coordinate system.

Another aspect of the disclosed and claimed concept is to provide a dimensioning apparatus and method that enable loads that are situated on mobile conveyances such as forklifts to be dimensioned when the loads are pivoted with respect to the floor.

Another aspect of the disclosed and claimed concept is to provide an improved dimensioning apparatus and method that enable an article that is on a movable conveyance to be dimensioned while ignoring the dimensions of the movable conveyance itself.

Accordingly, an aspect of the disclosed and claimed concept is to provide an improved method of employing a dimensioning apparatus to characterize a number of physical dimensions of a load with respect to a reference coordinate system having a number of reference axes when the load is situated in a detected position that is offset from the reference coordinate system by a displacement that comprises at least one of a number of translations along at least some of the number of reference axes and a number of rotations about at least some of the number of reference axes. The method can be generally stated as including identifying a number of points in space, at least some of which are each representative of a point on a surface of the load as situated in the detected position, receiving a number of signals that are representative of the displacement, based at least in part upon the number of signals, transforming at least some of the number of points in space into a number of transformed points in space that are each representative of a point on the surface of the load in a hypothetical position that corresponds with at least a portion of the reference coordinate system, and determining the number of physical dimensions based at least in part upon at least some of the number of transformed points in space.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of a calibration operation wherein a reference barcode fiducial is placed at a specific location with respect to a reference coordinate system within a detection zone of a dimensioning apparatus in accordance with the disclosed and claimed concept;

FIG. 1A is a schematic depiction of the dimensioning apparatus of FIG. 1;

FIG. 2 is a view similar to FIG. 1, except depicting a movable conveyance carrying a load and being received in the detection zone of the dimensioning apparatus; and

FIG. 3 is a view similar to FIG. 2, except depicting the movable conveyance and the load having been transformed by the dimensioning system of FIG. 1 such that the orientation of the load is virtually transformed to correspond with the reference coordinate system.

Similar numerals refer to similar parts throughout the specification.

### DESCRIPTION

An improved stationary dimensioning apparatus 4 enables an object or other type of load 8 (individually and collectively referred to herein as a “load”) that is situated on a vehicle 12 such as a forklift or other movable conveyance to be dimensioned while the load 8 remains situated on the vehicle 12. As will be described in greater detail below, the improved dimensioning apparatus 4 is advantageously configured, to enable the load 8 that is situated on the vehicle 12 to be accurately dimensioned regardless of the position and orientation of the load 8 with respect to the dimensioning apparatus 4.

The dimensioning apparatus 4 employs many elements that are similar to the dimensioning apparatus of Pangrazio such as a camera 20 and a laser device that are a part of an input apparatus 18 that operatively connected with and provides input signals to a computer apparatus 26. The computer apparatus has a processor 30 and a memory 34 and further having a number of software applications in the form of a number of routines 38 that are stored in the memory and that are executable on the processor 30 to cause the dimensioning apparatus 4 to perform certain operations. As employed herein, the expression “a number of” and variations thereof shall refer broadly to any non-zero quantity, including a quantity of one. The dimensioning apparatus 4 further includes an output apparatus 23 that receives output signals from the processor apparatus and that provides output such as a set of numbers that represent the physical dimensions or a dimensional weight of the load. Other types of outputs are possible depending upon the needs of the application.

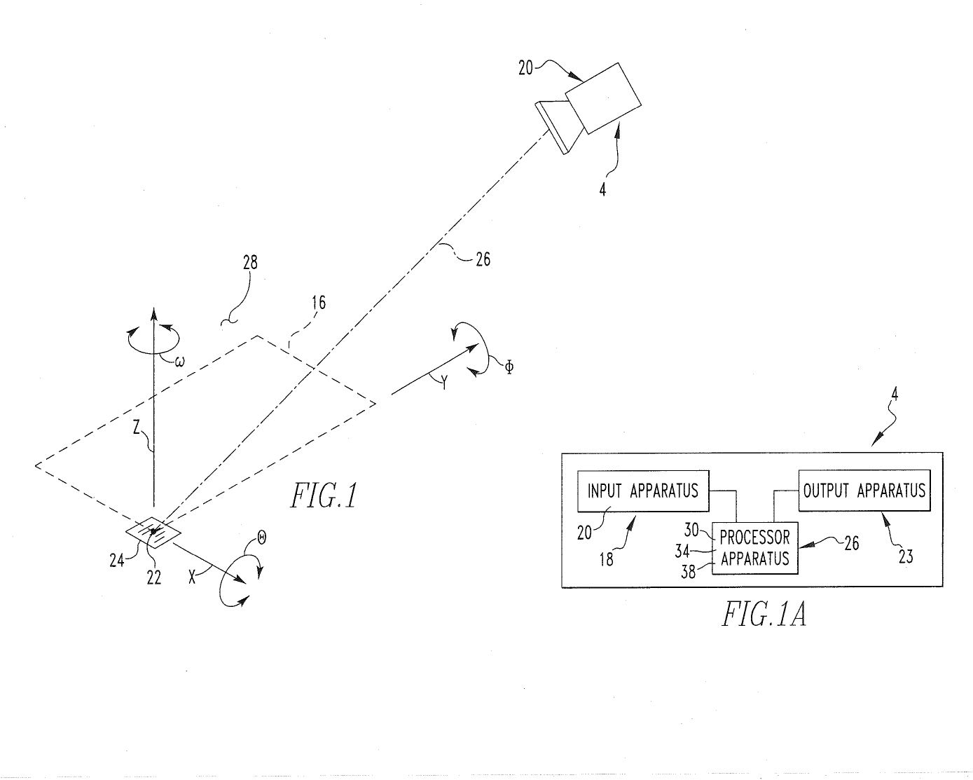

The dimensioning apparatus 4 is calibrated with the use of a calibration platform 16 that is depicted in dashed lines in FIG. 1 and that is of the type described in Pangrazio. As described in Pangrazio, the calibration platform 16 is situated at a plurality of different vertical positions within a dimensioning zone 28 of the dimensioning apparatus 4, and the camera 20 (that is representative of one or more cameras of the dimensioning apparatus 4) collects a series of images of the calibration platform 16 at each such vertical position. The dimensioning apparatus 4 employs these images to calibrate itself.

One such vertical position of the calibration platform 16 is a “zero-height” position along a z axis of an x, y, z coordinate system, which is a reference coordinate system whose axes x, y, and z are reference axes that are also depicted in FIGS. 1-3. In such a position the calibration platform 16 is situated within the x, y plane, which could be said to correspond with or to be aligned with the horizontal direction, and the x, y plane is situated at a height along the z axis that is at a value of zero. The z axis could be said to correspond with or to be aligned with the vertical direction. One corner of the calibration platform 16 (when the calibration platform 16 is in the zero-height position that is depicted in FIG. 1) is considered to be the origin of the x, y, z coordinate system. The origin is referred to herein as being the 0, 0, 0 point, which is indicated generally at the numeral 22 in FIG. 1, of the dimensioning apparatus 4. In general terms, all of the points of the “point cloud” that are detected by the dimensioning apparatus 4 are situated at some distance along each of the x, y, and z axes with respect to the 0, 0, 0 point 22 of the dimensioning apparatus 4. Each of the detected points of the “point cloud” thus have a set of detected coordinates x, y, z that characterized its detected, i.e., actual, position with respect to the reference coordinates x, y, z.

The dimensioning apparatus 4 advantageously further includes an additional software package in the form of additional routines 38 that are executable on the processor and that are capable of detecting a fiducial marker within the dimensioning zone 28. This software package is calibrated in a known fashion by positioning a reference object such as a calibration fiducial marker 24 in a plurality of random locations and at a plurality of random orientations within the dimensioning zone 28, and the software package self-calibrates based upon images taken by the camera 20 of the fiducial marker at the various locations.

As is depicted generally in FIG. 1, the calibration fiducial 24 in the exemplary form of a barcode label is situated in the dimensioning zone 28 such that the calibration fiducial 24 lies in the x, y plane and has its center at the 0, 0, 0 point 22 of the dimensioning apparatus 4. The calibration fiducial 24 is rectangular in shape, and two of its parallel edges correspond with the x axis, and the other two of its parallel edges correspond with the y axis. An image of the calibration fiducial 24 with its center at the 0, 0, 0 point 22 is recorded using the camera 20. A dot-dash line indicated at the numeral 26 in FIG. 1 represents the recordation by the camera 20 and the computer system connected therewith of the calibration fiducial 24 with its center at the 0, 0, 0 point 22. The recording of such an image can be said to be an additional part of the calibration procedure of the dimensioning apparatus 4 because it enables the camera 20 to relate the calibration fiducial 24 with the x, y, z coordinate system.

The calibration platform 16 is depicted in dashed lines in FIG. 1 in order to depict its position with respect to the center of the calibration fiducial 24, since the calibration platform 16 typically will have already been removed from the dimensioning zone 28 prior to positioning the calibration fiducial 24 at the 0, 0, 0 point 22. As can be seen in FIG. 1, the center of the calibration fiducial 24 is situated at the 0, 0, 0 point 22 of the dimensioning apparatus 4, and the edges of the calibration fiducial 24 are aligned with the x and y axes. Once the image of the calibration fiducial 24 with its center at the 0, 0, 0 point 22 of the dimensioning apparatus 4 has been recorded, the calibration fiducial 24 is removed from the dimensioning zone 28, and the calibration platform 16 is likewise removed from the dimensioning zone 28 if it has not already been removed.

After these procedures, the portion of the dimensioning apparatus 4 that detects the point cloud has been calibrated. Moreover, the fiducial detection software (which is the portion of the dimensioning apparatus 4 that detects fiducial markers such as the calibration fiducial 24) has recorded or otherwise stored an image of the calibration fiducial 24 with its center at the 0, 0, 0 point 22 of whatever “point cloud” will be detected by the dimensioning apparatus 4 when the load 8 is situated in the dimensioning zone 28. As mentioned above, the image of the calibration fiducial 24 was taken with the calibration fiducial 24 being situated in the x, y plane and with its edges being parallel with the x and y axes, and the orientation of the fiducial barcode 24 in such image therefore represents zero rotations in what can be referred to as θ, φ, and ω rotational directions, which are rotational directions about the x, y, and z axes, respectively. That is, the calibration fiducial 24 represents a zero-rotation orientation in the θ, φ, and ω rotational directions. The dimensioning apparatus 4 is thus fully calibrated and is ready for dimensioning.

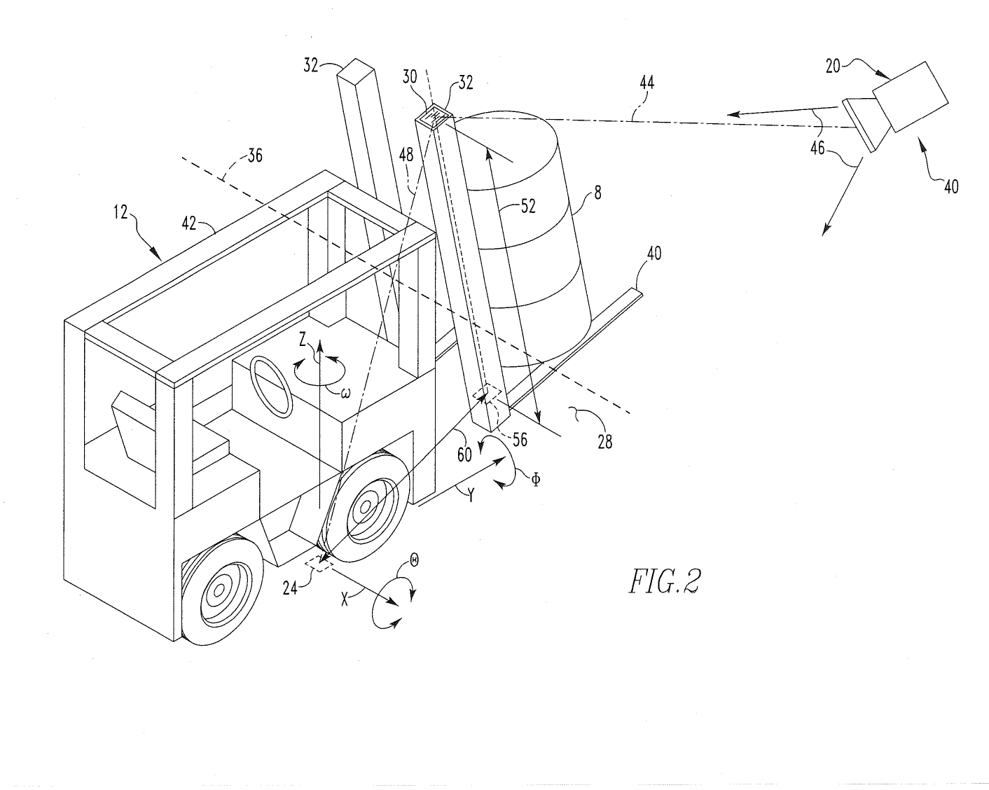

As can be seen in FIG. 2, the vehicle 12 having the load 8 thereon is driven from any direction into the dimensioning zone 28. As can be seen in FIG. 2, the vehicle 12 has a pair of masts 32, and one of the masts 32 has a mast fiducial 30 situated on an upper surface thereof. For reasons that will be set forth in greater detail below, the mast fiducial 30 alternatively can be placed elsewhere on the mast 32 and potentially elsewhere on the vehicle 12. In still other embodiments, such a fiducial can alternatively be placed on the load 8 itself. The mast fiducial 30 is, in the depicted exemplary embodiment, identical to the calibration fiducial 24 but is permanently affixed to the mast 32. The vehicle 12 further has a set of forks 40 that are supported by the masts 32 and that serve as a platform upon which the load 8 is situated. The forks 40 are movable along at least a portion of the longitudinal extent of the masts 32 in a known fashion.

The masts 32 are pivotable about a pivot axis 36 with respect to a body 42 of the forklift in a fore and aft direction with respect to the body 42, which can be referred to as effectively being a pitch axis from the perspective of the vehicle 12. The pivot axis 36 is typically situated at approximately the bottom of the masts 32. Moreover, it can be understood that the vehicle 12 potentially could be on a non-horizontal surface wherein the wheels on the right side of the vehicle 12 are at a different elevation than the wheels on the left side of the vehicle 12. In such a situation, the masts 32 might be controlled by an additional pivoting mechanism that might additionally enable the masts 32 to be pivoted from vertical in the left-right direction from the perspective of the vehicle 12, which could be referred to as a roll axis of the vehicle 12.

When the vehicle 12 with the load 8 situated on its forks 40 is received in the dimensioning zone 28, the camera 20 of the dimensioning apparatus 4 can detect the mast fiducial 30, and such detection is indicated by the dot-dash line 44 in FIG. 2. In particular, the fiducial detection software detects the position and orientation of the mast fiducial 30 (i.e., with respect to the camera 20), and the fiducial detection software can even characterize a normal vector extending from the center of the mast fiducial 30 (which will be used in a fashion set forth in greater detail below).

The fiducial detection software stores or otherwise records an image of the mast fiducial 30 (i.e., with respect to the camera 20, as is indicated with the line 44 in FIG. 2) and then compares that image with the aforementioned image of the calibration fiducial 24 (as was indicated with the line 26 in FIG. 1). It can be understood that the stored image of the calibration fiducial 24 and the stored image of the mast fiducial 30 are representations of the calibration and mast fiducials 24 and 30 with respect to the camera 20, which is at a fixed position. The fiducial detection software then derives from the two aforementioned images a translation vector and a rotation vector that each include a number of values that characterize the translational (i.e., positional) and rotational difference, respectively, between the calibration fiducial 24 that was stored during the calibration operation and the location of the mast fiducial 30 that is recorded during a dimensioning operation on the load 8.

In this regard, it is reiterated that the calibration fiducial 24 was positioned to correspond with the reference coordinate system and its reference axes x, y, and z. However, when load 8 is received in the detection zone 28 on the vehicle 12, the forks 40 are assumed to be offset from the x, y, z axes, meaning that the forks 40 and the load 8 will be displaced from the x, y, z axes by a number of translations along the x, y, z axes and a number of rotations about the x, y, z, axes in the θ, φ, and ω rotational directions, and this will nearly always be the case. That is, the vehicle 12 with the load 8 driven into the detection zone will nearly always (i.e., to a near certainty) carry the load 8 in position that is displaced from the reference coordinate system axes x, y, z by some type of translational and/or rotational offset. The “point cloud” that is detected in such a detected position of the load 8 (as in FIG. 2) thus will be points that are displaced or offset from the reference axes x, y, z by virtue of the masts 32 being tilted from vertical and/or by virtue of the wheels being on non-level surfaces and/or by virtue of the vehicle 12 being received in the detection zone 28 in a position non-parallel with the x axis. As will be set forth in greater detail below, the routines 38 advantageously transform the detected points in the “point cloud” into transformed points in space in a virtual fashion that removes the offset and rather virtually repositions the load 8 in an imaginary fashion that corresponds with and is not offset from the reference axes x, y, z in order to accurately assess the physical dimensions of the load with respect to the horizontal and vertical directions.

The translational and rotational difference between the calibration and mast fiducials 24 and 30 is represented in FIG. 2 by a dot-dash line that is indicated at the numeral 48, and the routines 38 characterize this difference 48 by calculating the aforementioned translation and rotation vectors. In this regard, it is noted that the calibration fiducial 24 is depicted in FIG. 2 in dashed lines merely to indicate its original position within the dimensioning zone 28 and with respect to the camera 20, although the calibration fiducial 24 likely would have been removed from the dimensioning zone 28 prior to the vehicle 12 being received in the dimensioning zone 28.

The translation vector is characterized as a set of distance values a, b, c and is representative of the distances along the x, y, and z axes (which are redrawn in FIG. 2 for purposes of convenience) between the center of the calibration fiducial 24 (which is at the 0, 0, 0 point 22 of the “point cloud” of the load 8, which will be mentioned in greater detail below) and the center of the mast fiducial 30. In a similar fashion, the rotation vector is in the form of a set of angular rotation values α, β, γ that describe the difference in rotation/orientation along the rotational directions θ, φ, and ω between zero-rotation orientation of the calibration fiducial 24 and the orientation of the mast fiducial 30.

For the sake of completeness, a pair of scanning lines that are indicted generally at the numeral 46 are depicted in FIG. 2 and are representative of the scanning that is done by the camera 20 and the operations by the other parts of the dimensioning apparatus 4 that are used to create the detected “point cloud”. That is, the detection of the mast fiducial 30 by the fiducial detection software and the detection of the point cloud by the dimensioning software can (and in the exemplary embodiment depicted herein does) occur substantially contemporaneously.

As is generally understood in the relevant art, the forks 40 are movable along at least a portion of the longitudinal extent of the masts 32 in order to lift the load 8 from a floor or other supporting surface, and it is reiterated that the masts 32 themselves are pivotable about the pivot axis 36 with respect to the body 42 of the vehicle 12. Moreover, and as has been set forth above, the vehicle 12 can be received in any direction into the dimensioning zone 28. As such, the “point cloud” generated by the dimensioning apparatus 4 includes points in space that are representative of the surface of the load 8 as well as other points in space that are representative of the surface of the vehicle 12. The dimensioning apparatus 4 identifies all of these detected points in space without knowing, at least initially, which points represent the load 8 and which points represent the vehicle 12.

As will be set forth in greater detail below, the dimensioning apparatus 4 advantageously distinguishes the points in the “point cloud” that are representative of an exterior surface of the load 8 from the other points in the “point cloud” that are representative of an exterior surface of the vehicle 12. This enables the dimensioning apparatus 4 to ignore the points in the “point cloud” that are representative of the vehicle 12, which is advantageous since the vehicle 12 is not what is being shipped, etc.

As will likewise be set forth in greater detail below, the dimensioning apparatus 4 further advantageously employs the points of the “point cloud” that are representative of the load 8 in a fashion that characterizes the load 8 in the orientation that the load 8 would take when shipped. For example, the load 8 is depicted in FIG. 2 as being pivoted in the pitch direction with respect to the vehicle 12 and/or with respect to the vertical direction, and as being further pivoted in the roll direction with respect to the vehicle 12 and/or with respect to the vertical direction. This is a result of the load 8 being situated on the forks 40 which are themselves pivoted in the pitch and roll directions by virtue of the forks 40 being situated on the masts 32 which are, in turn, mounted on the body 42 of the vehicle 12 which is itself situated on the ground or on the floor of a facility, which may be non-level. Without more, the detected “point cloud” on its own may present an erroneous characterization of the load 8 compared with how the load 8 will be situated on a horizontal surface in a cargo receptacle. It is understood, however, that the mast fiducial 30 is situated in a first plane atop the mast 32, and the upper surfaces of the forks 40 lie in or define a second plane. These first and second planes are parallel with one another but are spaced apart by a variable distance that depends upon the extent to which the forks 40 have been translated along the longitudinal extent of the masts 32.

In order to resolve these issues, it is observed that the pivot axis 36 has a fixed and known positional relationship with respect to the upper surface of the masts 32 where the mast fiducial 30 is located. In the depicted embodiment, this relationship is characterized in an exemplary fashion as being merely a distance 52 that is measured along the masts 32 and that is perpendicular to the plane of the mast fiducial 30. The fiducial detection software generates a normal vector 54 that extends out of the face of the barcode fiducial 30 at its center. The fiducial detection software then employs the normal vector 54, the distance 52, and the aforementioned translation vector to derive what can be characterized as an (imaginary) adjusted mast fiducial that is indicated with a dotted line in FIG. 2 at the numeral 56. The adjusted mast fiducial 56 represents the mast fiducial 30 after it has been effectively translated along the longitudinal extent of the masts 32 to an imaginary location internal to one of the masts 32 until the plane of the adjusted mast fiducial 56 is at a height along the masts 32 that corresponds with the pivot axis 36. That is, the mast fiducial 30 is effectively translated (in an imaginary fashion) through the masts 32 a distance equal to the distance 52, whereupon the resultant adjusted mast fiducial 56 is at an imaginary location internal to one of the masts 32 that is at the same position along the longitudinal extent of the masts 32 as the pivot axis 36. As such, a third imaginary plane that includes the adjusted mast fiducial 56 also includes the pivot axis 36.

The fiducial detection software then derives a transformation translation vector having a′, b′ and c′ values that characterize the distance along the x, y, and z axes between the center of the calibration fiducial 24 and the center of the adjusted mast fiducial 56. This transformation translation vector is represented in FIG. 2 by the line 60. In the depicted exemplary embodiment, it is unnecessary to calculate another rotation vector between the calibration fiducial 24 and the adjusted mast fiducial 56 since the only difference between the mast fiducial 30 and the adjusted mast fiducial 56 is a translation along the masts 32 by the distance 52, as is indicated by the normal vector 54. As such, the rotation vector α, β, γ between the calibration fiducial 24 and the mast fiducial 30 likewise characterizes the difference in orientation about the θ, φ, and ω rotational directions between the calibration fiducial 24 and the adjusted mast fiducial 56. The difference between the calibration fiducial 24 and the adjusted mast fiducial 56, as is indicated by the line 60 in FIG. 2, is thus represented by the transformation translation vector having the values a′, b′, c′ and the rotation vector having the values α, β, γ.

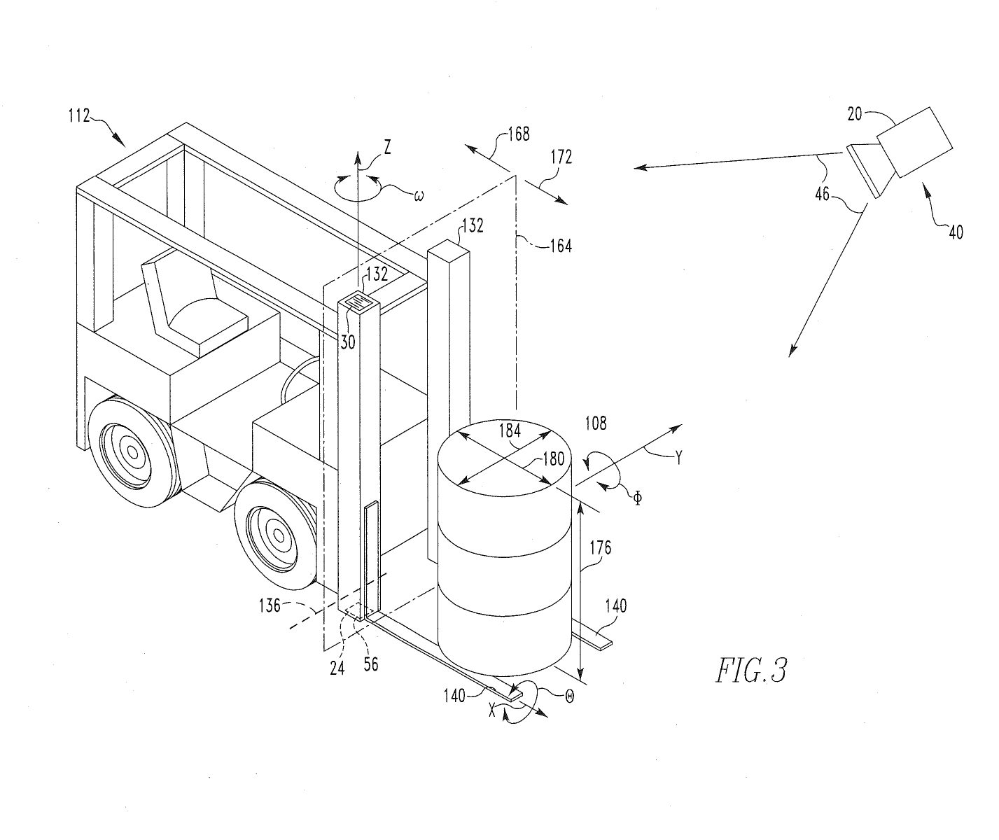

The transformation translation vector a′, b′, c′ and the rotation vector α, β, γ are then used to transform all of the detected points in the “point cloud” (as in FIG. 2) into transformed points in a transformed point cloud (as in FIG. 3). Such a transformation effectively (and in a virtual fashion) translates and rotates the vehicle 12 with the load 8 thereon as characterized by the detected points in the detected point cloud until the adjusted mast fiducial 56 is coincident with and precisely overlies the calibration fiducial 24, as is represented generally in FIG. 3. In such a transformed state, the masts 32 are oriented parallel with the z-axis, and the forks 40 extend parallel with the x-axis and are spaced apart from one another along the y axis. Such a transformation enables the load 8 to correspond with the x, y, z axes, meaning to no longer be offset therefrom, and to be characterized in generally the orientation that the load 8 will have when shipped, which is assumed to be situated on a horizontal surface of, say, a cargo hold of a truck, airplane, ship, etc.

As noted above, each detected point in the “point cloud” is designated by the dimensioning apparatus 4 as having coordinates (x, y, z), which represent the location of the point as a set of distances along the x, y, and z axes with respect to the 0, 0, 0 point 22. The transformation is accomplished by subjecting each of the (x, y, z) points in the detected “point cloud” to a transformation matrix that employs the a′, b′, c′ values from the transformation translation vector and the α, β, γ values from the rotation vector. More specifically, each point (x, y, z) is subjected to the aforementioned transformation matrix to generate therefrom a set of transformed points that are each designated with the coordinates (x′, y′, z′). Each set of (x′, y′, z′) coordinates represents a location of a transformed point as being a set of distances along the x, y, and z axes with respect to the 0, 0, 0 point 22. The transformation matrix is as follows:

$${x}^{′} {y}^{′} {z}^{′} = ( \begin{matrix}cos β cos γ & - cos β sin γ & sin β & x - {a}^{′} \\ \begin{matrix}cos α sin γ + \\ sin α sin β cos γ\end{matrix} & \begin{matrix}cos α cos γ - \\ sin α sin β sin γ\end{matrix} & - sin α cos β & y - {b}^{′} \\ \begin{matrix}sin α sin γ - \\ cos α sin β cos γ\end{matrix} & \begin{matrix}sin α cos γ + \\ cos α sin β sin γ\end{matrix} & cos α cos β & z - {c}^{′} \\ 0 & 0 & 0 & 1\end{matrix} )$$

Since the set of transformed points (x′, y′, z′) are representative of the vehicle 12 and the load 8 being translated and rotated (in a virtual fashion) until the adjusted mast fiducial 56 and the calibration fiducial 24 are coincident and the load 8 corresponds with (i.e., is no longer offset from) the axes x, y, z, as is depicted generally in FIG. 3, the transformed “point cloud” thus represents a transformed load 108 that is situated on a transformed vehicle 112 having a set of transformed forks 140 and a set of transformed masts 132, as depicted in FIG. 3. The transformed forks 140 extend parallel with the x axis, and the transformed masts 132 extend parallel with the z axis. Moreover, the transformed forks 140 are aligned with one another and are spaced apart from one another along the y axis, as are the transformed masts 132. As a result, the load 8 is (in a virtual fashion) reoriented to have its lower surface (or to have the pallet on which it is situated) be horizontal and to have a height in the vertical direction, i.e., to be in the orientation it would take during shipment.

With the transformed masts 132 extending parallel with the z axis, and with the transformed forks 140 extending parallel with the x axis, by virtue of the (x′, y′, z′) points that characterize them as such, a virtual curtain 164 can be defined immediately in front of the transformed masts 132. The curtain 164 is a predetermined boundary plane that effectively enables the dimensioning apparatus 4 to distinguish between those transformed points of the transformed “point cloud” that can be ignored (as being representative of the transformed vehicle 112) and the remaining transformed points of the transformed “point cloud” that should be employed in dimensioning the transformed load 108. In the depicted exemplary embodiment, the curtain 164 extends parallel with the y and z axes and is perpendicular to the x axis. Depending upon the position of the center of the mast fiducial 30 with respect to the frontal edge of the masts 32, the curtain 164 can be established (for example) just forward of the transformed masts 132, which might be, say, seven inches in front of both the mast fiducial 30 and the adjusted mast fiducial 56.

In such a scenario, any transformed point (x′, y′, z′) in the transformed “point cloud” can therefore be ignored if its x′ value is less than seven inches (the inch units being employed herein merely by way of example). This is illustrated in FIG. 3 with an arrow that is indicated at the numeral 168 and that represents the positions of all of the transformed points (x′, y′, z′) that are to be ignored (i.e., those being situated in the direction of the arrow 168 from the curtain 164). Likewise, another arrow indicated at the numeral 172 represents all of the remaining transformed points (x′, y′, z′) that will be employed to dimension the transformed load 108 (i.e., those being situated in the direction of the arrow 172 from the curtain 164). That is, the dimensioning apparatus 4 subjects all of the remaining, non-ignored transformed points (x′, y′, z′) to the operations described in Pangrazio to characterize the transformed load 108 and thus the load 8.

There may be one possible exception, however. As can be understood from the foregoing, the transformation of the points (x, y, z) into the transformed points (x′, y′, z′) results in a transformed pivot axis 136 of the transformed masts 132 that is at a zero position along the z axis from the 0, 0, 0 point 22. That is, the transformed pivot axis 136 lies in the x, y plane. Since the actual forks 40 can be at any of a variety of positions along the longitudinal extent of the actual masts 32, the transformed forks 140 and thus the transformed load 108 may therefore be positioned (virtually) in whole or in part above or below the x, y plane which, again, is the zero-height point along the z axis. This might result in the transformed load 108 effectively being spaced above the floor or being submerged into the floor.

In such a situation, a height 176 of the transformed load 108 can be determined by merely subtracting the smallest z′ value of all of the non-ignored transformed points (x′, y′, z′) from the greatest z′ value of all of the non-ignored transformed points (x′, y′, z′). Alternatively, however, other mathematical manipulations may be performed to arrive at the height 176. A length 180 and a width 184 of the transformed load 108 can be determined by employing the teachings of Pangrazio as applied to the non-ignored transformed points (x′, y′, z′) of the transformed “point cloud”, i.e., those points of the transformed “point cloud” that are situated in the direction of the arrow 172 with respect to the curtain 164. The dimensions of the transformed load 108, i.e., the height 176, the length 180, and the width 184, are thus employed as being the actual dimensions of the load 8, which are used for calculating shipping costs and for other purposes such as to efficiently load a cargo receptacle and the like.

As was suggested above, the mast fiducial 32 potentially can be placed in a location other than on an upper surface of one of the masts 30 without departing from the present concept. That is, the mast fiducial 32 can be placed on a frontal surface of one of the masts 30, on a lateral surface of one of the masts, etc., or elsewhere on the vehicle 12 as long as the location of such a fiducial (regardless of its particular position on a mast 30 or elsewhere) bears a fixed relationship with the pivot axis 36 and moves with the load 8.

Is also noted that the various operations set forth above can be performed in different sequences without departing from the present concept. For example, the curtain 164 can be established prior to the aforementioned transformation operation by defining a plane at some location in front of the masts 30. All of the various points (x, y, z) could then be compared with the plane, i.e., the curtain 164, and divided into ignored points (x, y, z) and non-ignored points (x, y, z) prior to the transformation operation. The non-ignored points (x, y, z) could then be subjected to the transformation operation mentioned above to result in the load 8 being transformed in the fashion depicted in FIG. 3 without additionally transforming all of the points (x, y, z) that relate to the vehicle 12 (and thus would ultimately be ignored). By performing such a distinction between ignored points (x, y, z) and non-ignored points (x, y, z) prior to performing the transformation operation, a savings in processing time and processing effort may potentially result from the transformation of fewer points (x, y, z).

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of employing a dimensioning apparatus to characterize a number of physical dimensions of a load with respect to a reference coordinate system having a number of reference axes when the load is situated in a detected position that is offset from the reference coordinate system by a displacement that comprises at least one of a number of translations along at least some of the number of reference axes and a number of rotations about at least some of the number of reference axes, the method comprising:
identifying a number of points in space, at least some of which are each representative of a point on a surface of the load as situated in the detected position;
receiving a number of signals that are representative of the displacement;
based at least in part upon the number of signals, transforming at least some of the number of points in space into a number of transformed points in space that are each representative of a point on the surface of the load in a hypothetical position that corresponds with at least a portion of the reference coordinate system; and
determining the number of physical dimensions based at least in part upon at least some of the number of transformed points in space.

2. The method of claim 1 wherein the load in the detected position is situated on a movable conveyance, and wherein the receiving of the number of signals comprises:
storing an image of a reference object situated at a known position with respect to the reference coordinate system; and
storing another image of another reference object situated on at least one of the conveyance and the load.

3. The method of claim 2, further comprising:
employing the image and the another image to derive at least one of a number of values that are at least in part representative of the number of translations along at least some of the number of reference axes and another number of values that are at least in part representative of the number of rotations about at least some of the number of reference axes; and
employing at least one of the number of values and the another number of values in the transforming of at least some of the number of points in space into the number of transformed points in space.

4. The method of claim 3 wherein the movable conveyance includes a platform upon which the load is situated and that is pivotable about a pivot axis with respect to the reference coordinate system, and further comprising:
storing as the another image an image of the another reference object situated on the conveyance; and
further employing a distance between the pivot axis and the another reference object to derive the at least one of a number of values.

5. The method of claim 1 wherein the load in the detected position is situated on a movable conveyance, and wherein the identifying of a number of points in space comprises identifying a number of other points in space that are each representative of a point on a surface of the conveyance, and further comprising ignoring all of the other points in space in the determining of the number of physical dimensions.

6. The method of claim 5 wherein each transformed point in space of the number of transformed points in space is described by a number of coordinates that characterize its position in space with respect to the number of reference axes, and wherein the ignoring comprises disregarding any transformed point in space whose number of coordinates place it beyond a predetermined boundary.

7. The method of claim 6 wherein the receiving of the number of signals comprises storing an image of a reference object situated at a known position with respect to the reference coordinate system, and storing another image of another reference object situated on the conveyance, and further comprising:
employing the image and the another image to derive at least one of a number of values that are at least in part representative of the number of translations along at least some of the number of reference axes and another number of values that are at least in part representative of the number of rotations about at least some of the number of reference axes;
employing at least one of the number of values and the another number of values in the transforming of at least some of the number of points in space into the number of transformed points in space; and
defining the predetermined boundary to be a virtual plane situated at a particular location with respect to the another reference object.

8. The method of claim 6 wherein the determining of the number of physical dimensions comprises calculating a height for the load by subtracting the smallest vertical coordinate among the transformed points in space from the tallest vertical coordinate among the transformed points in space.

9. A dimensioning apparatus structured to characterize a number of physical dimensions of a load with respect to a reference coordinate system having a number of reference axes when the load is situated in a detected position that is offset from the reference coordinate system by a displacement that comprises at least one of a number of translations along at least some of the number of reference axes and a number of rotations about at least some of the number of reference axes, the dimensioning apparatus comprising:
a processor apparatus comprising a processor and a storage;
an input apparatus structured to provide input signals to the processor apparatus;
an output apparatus structured to receive output signals to the processor apparatus;
the storage having stored therein one or more routines which, when executed on the processor, cause the dimensioning apparatus to perform operations comprising:
identifying a number of points in space, at least some of which are each representative of a point on a surface of the load as situated in the detected position;
receiving a number of signals that are representative of the displacement;
based at least in part upon the number of signals, transforming at least some of the number of points in space into a number of transformed points in space that are each representative of a point on the surface of the load in a hypothetical position that corresponds with at least a portion of the reference coordinate system; and
determining the number of physical dimensions based at least in part upon at least some of the number of transformed points in space.
